(19) United States
(12) Patent Application Publication
(10) Pub. No.: US 2004/0093102 A1
(43) Pub. Date: May 13, 2004

(54) Method and system for maintenance of a production plant

(76) Inventors: Sami Liiri, Jyvaskyla (FI); Kari Maki, Jyvaskyla (FI)

Correspondence Address: LATHROP & CLARK LLP, 740 REGENT STREET SUITE 400, P.O. BOX 1507, MADISON, WI, 537011507

(21) Appl. No.: 10/398,831

(22) PCT Filed: Oct. 8, 2001
(86) PCT No.: PCT/FI01/00866

(30) Foreign Application Priority Data
Oct. 10, 2000 (FI) 20002233

(51) Int. Cl. G06F 19/00

(52) U.S. Cl. 700/96; 702/184

(57) ABSTRACT

The invention relates to a method and system for the maintenance of a production plant. The method and system of maintenance is carried out in the production plant (100) on objects of work which comprise production plant equipment. In addition, a plan is worked out for maintenance, in which the objects of work to be checked and the actions to be carried out on them during each maintenance cycle are defined, and an equipment card is made for each object of work to be maintained, which equipment card is maintained on an application server (30). A portable computer (10) is brought into use for maintenance operations, which computer has a connection to the application server (30), each object of work is identified when maintenance is started, information relating to maintenance is fed into the potable computer (10) in connection with maintenance work, the information is transferred to the application server (30), the information is updated in an equipment card file on the application server (30), and the information on the results of maintenance is transferred from the application server (30) to the production plant.

The invention relates to a method for the maintenance of a production plant, in which method maintenance, for example, preventive maintenance, scheduled maintenance and checks associated with maintenance are carried out on objects of work which comprise production plant equipment or equipment units.

The invention also relates to a maintenance system for the maintenance of a production plant.

The invention relates to arranging the maintenance of a production plant such that information is transferred bidirectionally between the production plant and an application server located elsewhere to exchange information that supports service and maintenance. Paper mills, board mills, pulp production plants, paper finishing plants and similar plants associated with paper/board manufacture/converting are discussed in this application as examples of the production plant.

Conventionally, service of paper/board machines and equivalent is based on separate machine analyses, condition tests and service packages as well as on service agreements based on these, by means of which attempts are made to minimise the failure and disturbance factors in the production plant. In addition, in failure situations, service operations are perormed when the need arises. A maintenance unit may also collect continuous information about the condition of the production plant. Such information can be forwarded from the production plant to the maintenance unit, for example, on paper or in electronic form.

In accordance with the state of the art, preventive maintenance instructions are prepared for equipment delivered to a production plant, and by following the instructions the equipment remains in optimum operating condition. By optimising the maintenance instructions, attempts are made to keep the equipment in working order as long as possible. The maintenance instructions drawn up are included in a machine folder which is furnished with the equipment item/equipment group in question. At paper mills, planners of maintenance work collect maintenance information from the machine folders and make so-called work schedules out of the information for their own maintenance information system. The work schedules specify, among other things, the inspection and service interval of the equipment to be checked, the points to be checked and measured and, for example, possible replacement of oil or filters. The supervisor responsible for the equipment receives information from the maintenance information system at fixed intervals to do the job. A work request is generated out of the information and a work order is printed on paper. The printout shows the information filled in the work schedule.

Today's working method is based on information written down by a service technician about the services and inspections performed. The entry to be made in connection with an equipment item to be serviced is made temporarily on paper and entered at a later stage in the maintenance information system. In that connection, human errors or mistakes are always possible when the entry is made based on notes and entered afterwards in the maintenance information system. New work requests for service are made on the basis of faults detected after the entry.

It is an obiect of the present invention to develop a new method and system to serve as a maintenance aid in eliminating the above-mentioned problems.

It is also an object of the invention to provide a new method and system to serve as a maintenance aid in which maintenance information is updated in real time.

With a view to achieving the objects described above as well as those coming out later, the method according to the invention is mainly characterised in that the method comprises the steps of

working out a plan for maintenance, which plan defines the objects of work to be checked and the actions to be carried out on them during each maintenance cycle,

making an equipment card for each object of work to be maintained, which equipment card is maintained on an application server,

bringing a portable computer into use for maintenance operations, which computer has a connection to the application server,

identifying each object of work when maintenance is started,

feeding information relating to maintenance into the portable computer in connection with maintenance work,

transferring the information relating to maintenance to the application server,

updating the information relating to maintenance in an equipment card file on the application server, and

transferring the information on the results of maintenance from the application server to the production plant.

The maintenance system according to the invention is in turn characterised in that it comprises an equipment card file which is stored on an application server and in which information is stored in a given format, an identifying means for identifying an object of work, the application server for storing maintenance system information in the equipment card file, one or more portable computers from which a connection has been arranged to the application seer, and a data transmission connection to transmit information bidirectionally between the application server and a service centre as well as between the application server and a production plant.

In the method and system in accordance with the invention, a separate equipment card is made for each equipment unit of the production plant, which card contains all information needed in preventive maintenance or servicing of the equipment unit, which information varies depending on the type of equipment. By the equipment unit is meant an equipment item or an equipment group whose maintenance and servicing work is executed as a separate working step. Thus, each equipment item has an individual preventive maintenance plan of its own, which contains all inspection and measurement actions of the equipment with their inspection intervals. Such an equipment-specific preventive maintenance plan is worked out for the equipment units at the equipment manufacturer's factory and transferred to the customer's maintenance information system. Based on the preventive maintenance plan, the area supervisors in the customer's production plant receive at fixed intervals information about the need to do the necessary maintenance work, on the basis of which mechanics are given a work order to execute said work.

The equipment card file is advantageously located in an application server which is based on the use of an ASP (Application Service Provider) system. When using an ASP system, the customer's data and programs are arranged to be maintained by an outside service provider. The service provider takes care of all operations needed for data processing and software maintenance, of the compatibility and updates of the programs as well as of data transnission to a desired location. The data trsmission is arranged via the Internet or through a modem. The data trarnsission of the maintained data is restricted based on given read and write authorisations.

The application server using an ASP system typically serves several different companies in different data transmission and data processing needs. In the arrangement of the data to be transferred, a markup language is needed which contains information about the meaning of each data element. Such a markup language is, for example, XML (eXtensible Markup Language), in which the elements have been precisely defined which correspond to one another and by means of which the meaning of the data elements can be precisely coded into the contents of an XML document. Further processing of a finished XML document is easy with the help of computer programs. For example, data in XML form can be formulated by a suitable computer program into a presentation in HTML (Hyper Text Markup Language) form which can be read by commonly used browser software.

The equipment card file created by the XML markup language makes it possible to maintain the card file on an application server of an outside service provider, so that the service user need not get acquainted with the planning, software, data transmission and maintenance of the equipment card file. The service user can then concentrate in peace on his core know-how area.

As a means for transnitting work orders and for recording the work which has been completed, the mechanics use a portable work means in accordance with the invention, which means is advantageously a so-called palmtop PC, i.e. a PDA (Personal Digital Assistant) device. PDA devices are easy-to-handle, small-sized computers to which it is possible to connect as accessories, among other things, additional memory, a wireless network, a GPS module, a bar-code reader and a digital camera module. It is also possible to use another type of portable computer in accomplishing the arrangement in accordance with the invention.

The PDA device provides a wireless connection between the mechanic and the equipment card file located on the application server. The wireless connection is arranged, for example, by means of a GSM network or another known wireless data transmission connection. The equipment card file can also be located in another suitable data system. Examples of the information included in the equipment card are the serial number of the equipment, information on the model of the equipment, manufacturing material, the supplier of the equipment, order and sales numbers, a list of components, information about the barcode identifier of the equipment, installation instructions, preventive maintenance instructions, repair instructions, maintenance history and preventive maintenance history.

When starling a preventive maintenance cycle, the mechanic does not need any paper printout of the work order which would show the details of the equipment to be inspected but, in accordance with the invention, the mechanic contacts the application server with his PDA device and selects from the display of the PDA device the information about the preventive maintenance cycle of his own area. The interactive user interface of the PDA device informs the mechanic of all the items to be checked and asks the mechanic to input the inspection information on each equipment item. The equipment to be checked is identified, for example, by means of a bar code or by inputting identifier information by the PDA device. The mechanic inputs all the faults detected and the measurement/check results to the PDA device and the information is updated in real time into the application server. When the preventive maintenance cycle has been completed, the information is automatically transferred from the server to the maintenance system of the paper mill, in which connection a notice of the faults detected can be prepared. On the basis of the notice of faults, for example, a new work order is issued or a spare part order is made to replace a failed component with a new one.

The new type of information flow connection provided by the invention between the maintenance activities of the production plant and those controlling maintenance enables several new modes of operation in providing maintenance, preventive maintenance and service. At the same time as the information in the equipment cards is updated in real tine when information is transferred directly from the equipment to be maintained to the application server, information can be collected from several production plants maintained on the application on server and summaries and statistical analyses can be made of the maintenance operations of the various plants. The need for future preventive maintenance and service can be predicted based on this sunmary information, which is useful, among other things, when assessing the need for spare parts.

The system in accordance with the invention makes it possible for the production plant's equipment supplier to monitor the maintenance operations performed in the production plant and to supervise the implementation of preventive maintenance. In that case, machines and equipment groups can be given, for example, operational reliability guarantees more easily than before. When several production plants adopt the preventive maintenance system in accordance with the invention, the data obtained from the different plants and collected to the application server can be compared with one another.

The system in accordance with the invention also provides a better opportunity than before to monitor the working hours used for maintenance because the time used for all operations is automatically recorded in the equipment card file. This enables, among other things, better monitoring of costs.

In the following, the invention will be described in detail with reference to some exemplifying embodiments of the invention schematically shown in the figures of the appended drawing, to which embodiments the invention is not meant to be exclusively confined.

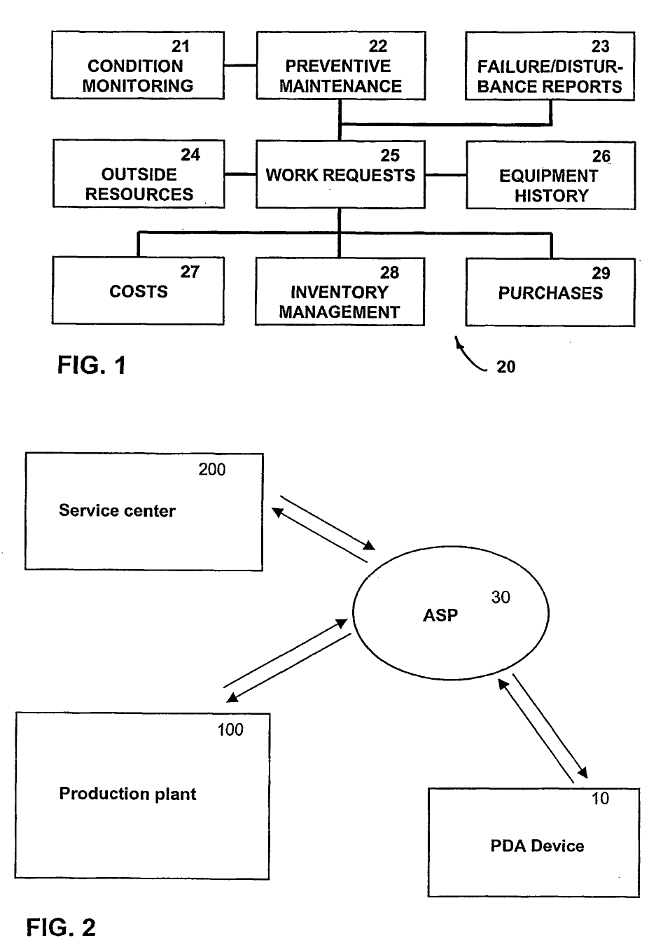

FIG. 1 shows, in the form of a block diagram, functions associated with condition monitoring in a production plant.

FIG. 2 shows a communications connection in accordance with the invention in connection with condition monitoring.

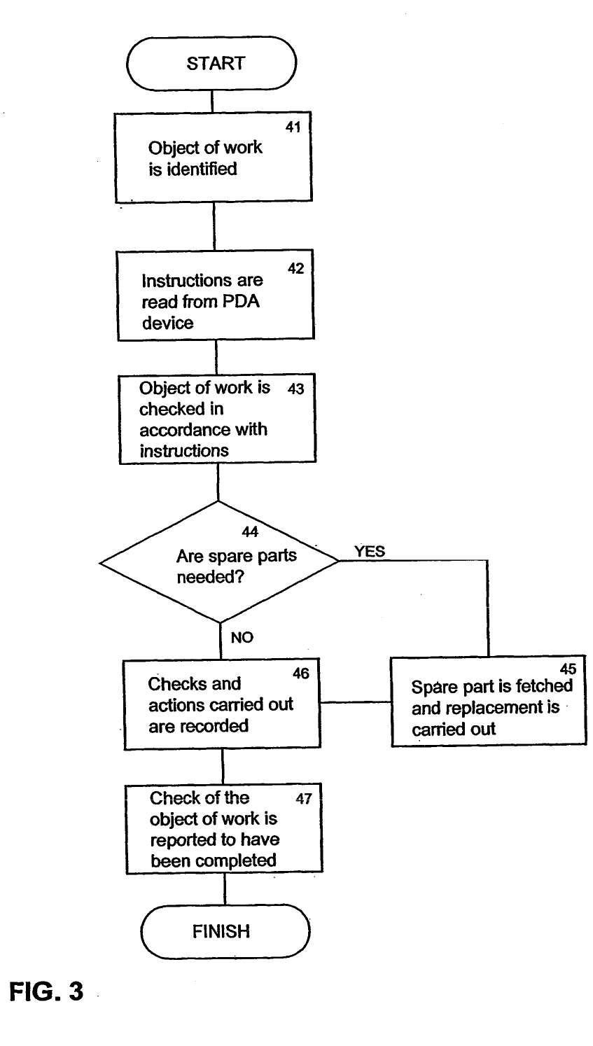

FIG. 3 shows, in the form of a flow chart, an example of the operation of a condition monitoring system in accordance with the invention.

FIG. 1 shows a condition monitoring system 20 in accordance with the prior art. The condition monitoring system 20 comprises the following functions: condition monitoring actions 21, preventive maintenance actions 22, failure/disturbance reports 23, outside resources 24, generation of work requests 25, maintenance of equipment history 26, maintenance costs 27, inventory management 28, and purchase activities 29. The system in accordance with the invention can be made use of in particular in cormection with condition monitoring 21, in connection with preventive maintenance 22, in handling failure/disturbance reports 23, in making work requests 25 and in maintaining equipment history 26.

FIG. 2 shows a system in accordance with the invention for control of maintenance information. The system comprises a production plant 100, one or more PDA devices 10 used in the production plant 100, an application server, i.e. ASP 30, and a service centre 200. Advantageously, the entire personnel carrying out maintenance have PDA devices at their disposal. The service centre 200 can be an independent unit which serves various production plants giving maintenance recommendations, or it can be a unit maintained by a supplier of the production plant, for example, a paper machine manufacturer. The service centre 200 communicates with the ASP 30 exchanging information needed in the maintenance of the production plant 100. The information passed to the ASP 30 from the service centre 200 may be, for example, updating of equipment cards or forwarding of new maintenance recommendations. The ASP 30 communicates with both the production plant 100 and the PDA device 10. It is essential to the system in accordance with the invention that the production plant 100 receives through the ASP 30 only the information it needs and has requested, in which connection no extra data processing steps need be carried out in the production plant 100.

Between the ASP 30 and the units communicating with it there is a secure communications connection with ensured data integrity, Only those who have a verified right to access to data or to entry of data receive information from the ASP.

FIG. 3 shows, in the form of a flow char; an example in a maintenance situation in connection with an equipment item to be checked in a production plant, i.e. in connection with an object of work. At first, the object of work to be checked is identified (step 41), for example, by reading by a PDA device the bar code attached to the object of work, by reading the identification information of the object of work by another optical method or by feeding an identification code manually to the PDA device.

After identification, the instructions for checking and servicing the identified object of work are read from the PDA device in the step 42. The necessary actions are carried out on the object of work in accordance with the given instructions (step 43). If spare parts are needed (step 44), a spare part is fetched and substituted for a failed component (step 45). Finally, the actions carried out are recorded (step 46) into the PDA device and the check of the object of work is recorded as completed (step 47). The information which has changed in connection with the check is automatically transferred from the PDA device to an application server, i.e. an ASP. On the application server the new data are recorded in the equipment card file, from which they are available to both the production plant and remote service.

A practical example of accomplishing a maintenance operation in accordance with the invention is described below. A service technician of a production plant starts to make a preventive maintenance round. He loads the preventive maintenance cycle of his own area to the PDA device from an application server maintained by an outside service provider. The PDA device loads fiom the application server the information and the inspection order of the equipment units, i.e. the objects of work, to be checked during the preventive maintenance cycle. In the beginning of the inspection cycle, the PDA device informs “1st inspection point: rope tightener of the 2nd dryer group”. On arriving at said object of work, the service technician reads by the PDA device the bar code attached to the equipment, whereupon the PDA device informs about the checks to be carried out on this item based on the information contained in the corresonding equipment card. After completing each check indicated by the PDA device, the service technician stores the results immediately into the PDA device. When all the actions proposed by the PDA device have been completed and the corresponding information stored, the laptop PC shows the next inspection point: “The next point: rope tightener of the 3rd dryer group”. All the action requests provided by the PDA device must be answered in order that the next action shall be shown on the display and progress may be made on the maintenance round.

When all the objects of work on the round have been gone through, the service technician records the completion of the cycle into the PDA device. The application server will then receive information that all the items of the cycle have been gone through. The equipment supplier also receives, if needed, from the application server information about the inspection and can thus maintain usability guarantee.

An alternative to the fully real-time updating of the equipment card file on the application server directly from a PDA device is to load maintenance information to a PDA device from the application server before starting a maintenance round. In that connection, the results of the maintenance round are unloaded only after the round and transferred to the application server. In that case, the PDA device need not be in a continuous wireless connection with the application server but the connection can be arranged in a centralised manner, for example, to the information network of the production plant through a docking station provided for PDA devices.

The method and the system in accordance with the present invention can also be utilised in connection with a delivery of equipment. In that connection, equipment cards of the equipment items to be installed are made in advance and stored in the application server and, at the installation stage, information about the progress of installation is fed into the PDA device. The equipment card can contain information about installation instructions, which are easy to trnsmit to the installation site by the method according to the invention. The input information given by the mechanic is accompanied by information about the installation time and, based on this information, it is possible to monitor whether installation progresses according to the planned schedule.

The method and the system in accordance with the invention are also useful when used by an outside service technicians. When, for example, a service technician of an equipment supplier is going to the production plant to carry out a repair under guarantee or some other maintenance, he loads into a PDA device the equipment cards of the equipment to be serviced, which cards provide information about the object of service already before arrival at the site of work. On the site of work, the service technician starts the job by reading the bar code of the equipment item to be serviced and receives after this action service instructions to the PDA device. The service technician inputs the actions carried out in connection with the work whereby the equipment card is updated on the application server in real time and the results of the work can be immediately monitored both in theproduction plant and in the service centre.

In the examples described above, the production plant 100 is, for example, a paper mill, a board mill, a pulp production plant, a paper finishing plant or an equivalent plant associated with paper/board manufacture/convertng or another production plant.

The claims are presented in the following and the various deals of the invention may vary within the inventive idea defined by said claims and differ from the disclosure given above by way of example only.

1. A method for the maintenance of a production plant, which is a paper mill, a board mill, a pulp production plant, a paper finishing plant or an equivalent plant associated with paper/board manufacture/converting, in which method maintenance, for example, preventive maintenance, scheduled maintenance and checks associated with maintenance are carried out in the production plant 100 on objects of work which comprise production plant equipment or equipment units, characterised in that the method additionally comprises the steps of,
working out a plan for maintenance, which plan defines the objects of work to be checked and the actions to be carried out on them during each maintenance cycle,
making an equipment card for each object of work to be maintained, which equipment card is maintained on an application server (30),
bringing a portable computer (10) into use for maintenance operations, which computer has a connection to the application server (30),
identifying each object of work when maintenance is started,
feeding information relating to maintenance into the portable computer (10) in connection with maintenance work,
transferrng the information relating to maintenance to the application server (30),
updating the information relating to maintenance in an equipment card file on the application server (30), and
transferring the information on the results of maintenance from the application server (30) to the production plant.

2. A method according to claim 1, characterised in that the portable computer (10) is in a wireless connection with the application server.

3. A method according to claim 1 or 2, characterised in that the object of work is identified by means of a bar code or another marking, which is read by the portable computer (10) optically or by some other identification method.

4. A method according to any one of claims 1 to 3, characterised in that the object of work is identified from an identification code which is fed into the portable computer (10).

5. A method according to any one of claims 1 to 4, characterised in that the serial number of the object of work, i.e. an equipment item or an equipment unit, information on the model of the equipment, manufacturing material, the supplier of the equipment, order and sales numbers, a list of components, information on the barcode identifier of the equipment, installation instructions, preventive maintenance instructions, repair inrructions, maintenance history andlor preventive maintenance history are stored in the equipment card.

6. A method according to any one of claims, 1 to 5, characterised in that information on the results of maintenance is transferred from the application server (30) to the production plant (100). and, in failure situations, the necessary spare part(s) is/are ordered and/or repair work is ordered.

7. A method according to any one of claims 1 to 6, characterised in that the need for future maintenance work is predicted based on the information gathered into the application sever (30).

8. A maintenance system for the maintenance of a production plant, which is a paper mill a board mill, a pulp production plant, a paper finishing plant or an equivalent plant associated with paper/board manufacture/converting, characterised in that it comprises an equipment card file which is stored on an application server (30) and in which information is stored in a given format, an identifyig means for identifying an object of work the application server (30) for storing maintenance system information in the equipment card file, one or more portable computers (10) from which a connection has been arranged to the application server, and a data transmission connection to transmit information bidirectionally between the application server (30) and a service centre (200) as well as between the application server (30) and the production plant (100).

9. A maintenance system according to claim 8, characterised in that the equipment card file comprises equipment cards for the equipment belonging to the maintenance system, the information in said cards being stored in the XML format.

10. A maintenance system according to claim 8 or 9, characterised in that the identifying means of the object of work is a bar code or another marking which can be read optically or by some other identification method.

11. A maintenance system according to any one of claims 8 to 10, characterised in that the equipment card includes, for example, the following information on the equipment to be maintained: a serial number, information on the model of the equipment, manufacturing material, the supplier of the equipment, order and sales numbers, a list of components, information on the barcode identifier of the equipment, installation instructions, preventive maintenance instructions, repair instructions, maintenance history and/or preventive maintenance history.

12. A maintenance system according to any one of claims 8 to 11, characterised in that the application server (30) complies with the ASP system.

13. A maintenance system according to any one of claims 8 to 12, characterised in that information is arranged to be traitted from the application server (30) or to the application server (30) only by those who are authorised to do so.

14. A maintenance system according to any one of claims 8 to 13, characterised in that the portable computer (10) compnises a reader for reading a bar code or another identification means.

15. A maintenance system according to any one of claims 8 to 14, characterised in that a wireless data transmission connection is arranged from the portable computer (10) to communicate with the application server (30).

16. A maintenance system according to any one of claims 8 to 15, characterised in that the portable computer (10) comprises a user interface which is arranged for processing preventive maintenance information and for storing information.

17. A maintenance system according to any one of claims 8 to 16, characterised in that the user interface of the portable computer (10) is interactive.

18. A maintenance system according to any one of claims 8 to 17, characterised in that the portable computer (10) is a PDA (Personal Digital Assisant) device.
